(19) United States
(12) Patent Application Publication
(10) Pub. No.: US 2016/0087891 A1
(43) Pub. Date: Mar. 24, 2016

(54) PATH COMPUTATION ELEMENT AND METHOD FOR SETTING PATH OF USER NETWORK INTERFACE

(71) Applicant: ELECTRONICS AND TELECOMMUNICATIONS RESEARCH INSTITUTE, Daejeon (KR)

(72) Inventors: Tae Hyun KWON, Andong-si (KR); Sun Me KIM, Daejeon (KR); Jong Hyun LEE, Daejeon (KR); Dong Guk JE, Daejeon (KR); Eun Young CHO, Daejeon (KR); Kyeong Eun HAN, Daejeon (KR)

(21) Appl. No.: 14/810,857

(22) Filed: Jul. 28, 2015

(30) Foreign Application Priority Data
Sep. 22, 2014 (KR) 10-2014-0125959

(51) Int. Cl. H04L 12/56; H04L 12/721; H04L 29/12; H04L 12/723

(52) U.S. Cl. CPC H04L 45/741; H04L 45/50; H04L 45/14; H04L 61/2596

(57) ABSTRACT

Provided herein is a path computation element based on Transport Network Assigned (TNA) address and a method for path computation based on User Network Interface (UNI). The path computation element and UNI based path computation method of the present disclosure minimize overhead caused by abstract Traffic Engineering (TE) link, and minimize manual environment set up, and routing information exchange and advertisements in a local domain or between domains.

### CROSS-REFERENCE TO RELATED APPLICATION

The present application claims priority to Korean patent application number 10-2014-0125959, filed on Sep. 22, 2014, the entire disclosure of which is incorporated herein in its entirety by reference.

### BACKGROUND

1. Field of Invention

Various embodiments of the present disclosure relate to setting up a path for a network system, and particularly, to a path computation element capable of minimizing routing information exchange and advertisements when setting up a User Network Interface path, and a method for setting the User Network Interface path.

2. Description of Related Art

In order to provide new services at high speed, intelligent transport networks are needed. Thus, the ITU-T (International Telecommunications Union Telecommunication) recommends the ASON (Automatically Switched Optical Network) which is an automated transport network control plane structure. Furthermore, the GMPLS (Generalized Multi-protocol Label Switching) defined by the IETF (Internet Engineering Task Force) is being adopted as a common control plane protocol.

The OIF (Optical Internetworking Forum) defines specifications related to User Network Interface (hereinafter referred to as ‘UNI’) and External Network-Network Interface (E-NNI). Herein, a client device includes a UNI of client side (hereinafter referred to as ‘UNI-C’), and the network device includes a UNI of network side (hereinafter referred to as ‘UNI-N’). Therefore, a UNI means a service control interface that connects the UNI-C and UNI-N.

Herein, a UNI path is a path set up between ends (UNI-Cs or UNI-Ns) based on a Transport Network Assigned (hereinafter referred to as ‘TNA’) address. For example, the UNI path is a path set up based on a source TNA address and a destination TNA address. The UNI path may be set up between one UNI-C and another UNI-C, or between one UNI-N and another UNI-N.

To control the UNI path, UNI signaling (for example, RSVP-TE: Resource Reservation Protocol-Traffic Engineering) is used.

To compute and set up such a UNI path, overheads are used that have been configured in advance to form and manage Traffic Engineering (hereinafter referred to as ‘TE’) links between border nodes in a full mesh or partial mesh format.

Furthermore, in terms of routing protocol, there may be overheads caused by abstract TE link advertising. In the worst case, when there are N border nodes in a full mesh format, the link advertising cost may be O(n²).

Consequently, there occurs a problem that in order to set up a UNI path, there may be overheads due to the routing information and advertisements being transmitted in the network, and the greater the size of the network, the greater the overhead becomes.

### SUMMARY

A first purpose of the present disclosure is to provide a path computation element and a UNI path set up method capable of minimizing the overhead caused by abstract Traffic Engineering (TE) links formed between border nodes.

Another purpose of the present disclosure is to provide a path computation element and a UNI path set up method capable of minimizing routing information exchange and advertisements when setting up the UNI path.

An embodiment of the present disclosure provides a path computation element including an information collecting and managing unit configured to collect and manage information; a plurality of databases configured to store information collected by the information collecting and managing unit; an engine unit configured, in response to receiving a request to compute a UNI (User Network Interface) path, to compute the path using the plurality of databases according to the request to compute the path and to output a result of computing the path, wherein the engine unit computes the path by converting a source TNA (Transport Network Assigned) address of a source node into a source node address, converting a destination TNA address of a destination node into a destination node address, and computing the path based on a domain where the destination node is located at the request to compute the path.

In this embodiment, the plurality of databases may include a traffic engineering database configured to store network topology and resource information; a domain sequence database configured to store information on a domain sequence; a network assigned address database configured to store mapping information of a network assigned address and a node address; and a policy database configured to store policy information for path computation.

In this embodiment, the engine unit may determine whether or not the address of the source node and destination node is a TNA address.

In this embodiment, the source node address and the destination node address may be Label Switch Router IDs (LSR IDs).

In this embodiment, the Label Switch Router ID may be the same as a router ID or a Traffic Engineering (TE) Router ID, or may be the router ID or the Traffic Engineering (TE) Router ID.

In this embodiment, the engine unit may use a Path Computation Element Protocol (PCEP) and an expanded PCEP.

In this embodiment, the engine unit may incorporate the source TNA address and destination TNA address into an endpoint object of a PCEP message and transmit the same when using the PCEP.

In this embodiment, the engine unit may include information for identifying an internet protocol version 4 (IPv4) TNA address, internet protocol version 6 (IPv6) TNA address, and NASP TNA address in order to distinguish between the TNA address and node address in an Object Type (OT) of a common object head of the PCEP message.

In this embodiment, the engine unit may include information for identifying an internet protocol version 4 (IPv4) TNA address, internet protocol version 6 (IPv6) TNA address, and NASP TNA address in order to distinguish between the TNA address and node address in a TLV type of an endpoint object of the PCEP message.

In this embodiment, the engine unit may incorporate the TNA address in the endpoint object, expands a generalized endpoint object and incorporates the TNA address into the expanded generalized endpoint object, or incorporates the TNA address into a newly defined PCEP.

In this embodiment, the engine unit may use the PCEP that comprises information for identifying the TNA address.

In this embodiment, the path computation element may be connected to a Path Computation Client (PCC) and compute the path, and the PCC may use the PCEP to transmit the TNA address.

Another embodiment of the present disclosure provides a User Network Interface (UNI) path computation method including receiving a user network interface path computation message; in response to a source address at a path computation request being a source Transport Network Assigned (TNA) address, converting the source TNA address into a source node address; in response to a destination address at the path computation request being a destination TNA address, converting the destination TNA address into a destination node address; and computing a path at the path computation request based on a domain where the destination node is located.

In this embodiment, the path computation request message and path computation response message may use a Path Computation Element Protocol (PCEP) and an expanded PCEP.

In this embodiment, the path computation request message and path computation response message may incorporate a source TNA address and a destination TNA address using an endpoint object of an PCEP message when using the PCEP.

In this embodiment, the PCEP message may include information for identifying an internet protocol version 4 (IPv4) TNA address, internet protocol version 6 (IPv6) TNA address, and NASP TNA address in order to distinguish between the TNA address and node address in an Object Type (OT).

In this embodiment, the PCEP message may include information for identifying an internet protocol version 4 (IPv4) TNA address, internet protocol version 6 (IPv6) TNA address, and NASP TNA address in order to distinguish between the TNA address and node address in a TLV type of an endpoint object.

In this embodiment, the path computation request message and path computation response message may include information for identifying the TNA address in a predefined object in the PCEP.

In a path computation element of according the aforementioned embodiments of the present disclosure, there is no need to configure abstract Traffic Engineering (TE) links beforehand when setting up a UNI, and thus it is possible to reduce the overhead for abstract TE link configuration. Furthermore, the path computation element may identify a Transport Network Assigned (TNA) address, and compute a UNI path through conversion to node address, thereby minimizing routing information exchange and advertisements. Furthermore, it is also possible to provide a UNI path computation element and UNI path set up method based on TNA address both when TNA addresses are being advertised between domains according to the routing policy and when TNA addresses are not being advertised between domains due to confidentiality, expandability, and protocol compatibility.

### BRIEF DESCRIPTION OF THE DRAWINGS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the drawing figures, dimensions may be exaggerated for clarity of illustration. It will be understood that when an element is referred to as being “between” two elements, it can be the only element between the two elements, or one or more intervening elements may also be present. Like reference numerals refer to like elements throughout.

FIG. 1 is an exemplary view of a transport network providing a UNI path;

FIG. 2 is an exemplary view of a network for computing and setting up a TNA address based UNI path;

FIG. 3 is an exemplary view of setting up a UNI path in a network using a Switched Connection (SC)method;

FIG. 4 is an exemplary view of setting up a UNI path in a network using a Soft Permanent Connection (SPC) method;

FIG. 5 is a view of a path computation element and a network where TNA address is being advertised between domains according to an embodiment of the present disclosure;

FIG. 6 is an exemplary view of setting up a UNI path using the SC method in the network of FIG. 5;

FIG. 7 is an exemplary view of setting up a UNI path using the SPC method in the network illustrated in FIG. 5;

FIG. 8 is a view of path computation element and a network where TNA address is not being advertised between domains according to an embodiment of the present disclosure;

FIG. 9 is an exemplary view of setting up a UNI path using the SPC method in the network illustrated in FIG. 8;

FIG. 10 is an exemplary view of setting up a UNI path using the SC method in the network illustrated in FIG. 8;

FIG. 11 is an exemplary view of setting up a UNI path in a single domain using the SC method in the network illustrated in FIG. 8;

FIG. 12 is an exemplary view of setting up a UNI path in a single domain using the SPC method in the network illustrated in FIG. 8;

FIG. 13 is a view of a path computation element according to an embodiment of the present disclosure;

FIGS. 14A and 14B are flowcharts of a path computation method of a path computation element according to an embodiment of the present disclosure;

FIG. 15 is a view of a PCEP common object head structure for identifying TNA address according to an embodiment of the present disclosure;

FIG. 16 is a view of an endpoint object body format for NASP TNA address according to an embodiment of the present disclosure;

FIG. 17 is a view of a generalized endpoint object structure for identifying TNA address according to another embodiment of the present disclosure; and

FIG. 18 is a view of a NASP TNA address TLV format for NASP TNA address according to an embodiment of the present disclosure.

### DETAILED DESCRIPTION

Hereinafter, embodiments will be described in greater detail with reference to the accompanying drawings. Embodiments are described herein with reference to cross-sectional illustrations that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as ‘first’ and ‘second’ may be used to describe various components, but they should not limit the various components. Those terms are only used for the purpose of differentiating a component from other components. For example, a first component may be referred to as a second component, and a second component may be referred to as a first component and so forth without departing from the spirit and scope of the present disclosure. Furthermore, ‘and/or’ may include any one of or a combination of the components mentioned.

Furthermore, a singular form may include a plural from as long as it is not specifically mentioned in a sentence. Furthermore, “include/comprise” or “including/comprising” used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

It is also noted that in this specification, “connected/coupled” refers to one component not only directly coupling another component but also indirectly coupling another component through an intermediate component. On the other hand, “directly connected/directly coupled” refers to one component directly coupling another component without an intermediate component.

The present disclosure provides a path computation element capable of minimizing routing information exchange and advertisement when setting up a User Network Interface (hereinafter referred to as ‘UM’) and a UNI path set up method thereof. For example, hereinafter, explanation on the path computation element will be made in the case of setting up a UNI path in a transport network. However, it should be appreciated that the path computation element of the present disclosure may also apply the UNI set up operations that will be provided herein when setting up a path in other types of interfaces as well.

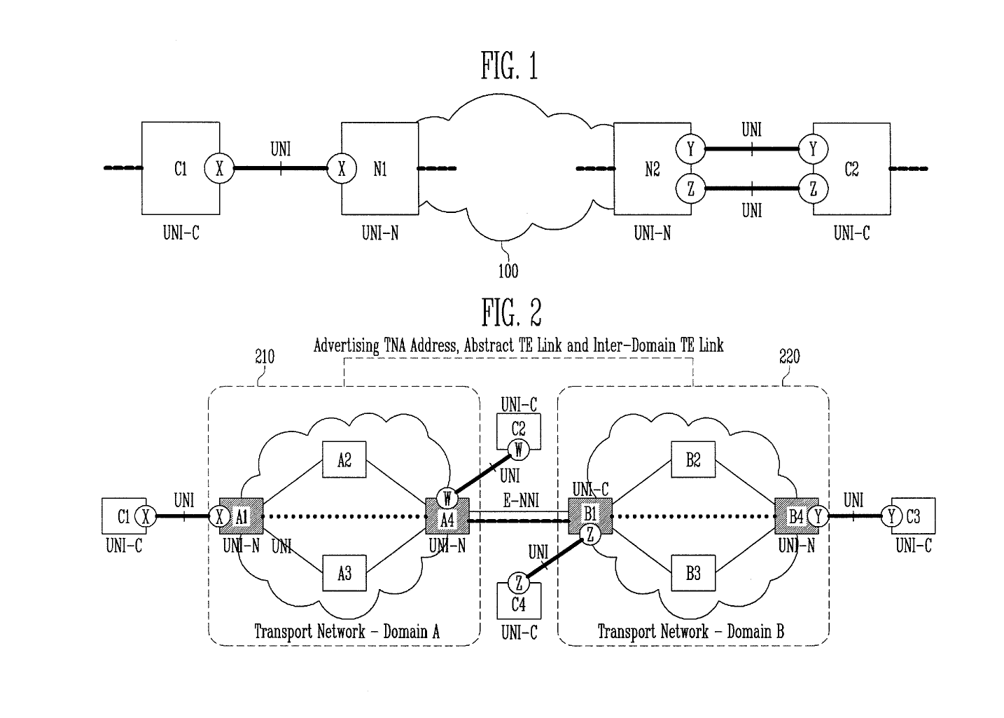

FIG. 1 is an exemplary view of a transport network that provides a UNI path.

Referring to FIG. 1, in the transport network (100), there are network nodes (N1, N2), and client nodes (C1, C2) are connected through these network nodes.

Herein, the network nodes (N1, N2) include UNIs of network side (hereinafter referred to as ‘UNI-N’). A UNI-N is defined as a logic entity that performs UNI signaling at the network side.

Furthermore, the client nodes (C1, C2) include UNIs of client side (hereinafter referred to as ‘UNI-C’). The UNI-C is a logic entity that performs UNI signaling at the client side.

Furthermore, a Transport Network Assigned (hereinafter referred to as ‘TNA’) address is an address assigned to a data bearing link (interface or port) that connects a UNI-N and UNI-C, that is, a UNI link (interface or port) in order to identify clients (or client nodes C1, C2). Herein, TNA addresses are marked with circles (X, Y, Z) in each UNI-C and UNI-N. A TNA address corresponds to a TNA name or UNI transport identifier. Types of these TNA addresses include an Internet Protocol version 4 (IPv4) TNA address, Internet Protocol version 6 (IPv6) TNA address, and Network Service Access Point (NSAP) TNA address. Furthermore, a plurality of TNA addresses (for example Y, Z) may be assigned to one node such as in the second network device (N2) and the second client (C2).

Herein, the TNA addresses assigned to the network nodes (N1, N2) are advertised in a local domain and between domains by an External Network-Network Interface (hereinafter referred to as ‘E-NNI’) routing function together with a node ID (or router ID or Traffic Engineering (hereinafter referred to as ‘TE’) router ID).

Herein, a UNI path is a path set up between ends (UNI-Cs or UNI-Ns) based on Transport Network Assigned (hereinafter referred to as ‘TNA’) addresses of the node ends. For example, the UNI path is a path set up based on a source TNA address and a destination TNA address. Through the aforementioned, a UNI path may be set up between one UNI-C and another UNI-C or between one UNI-N and another UNI-N.

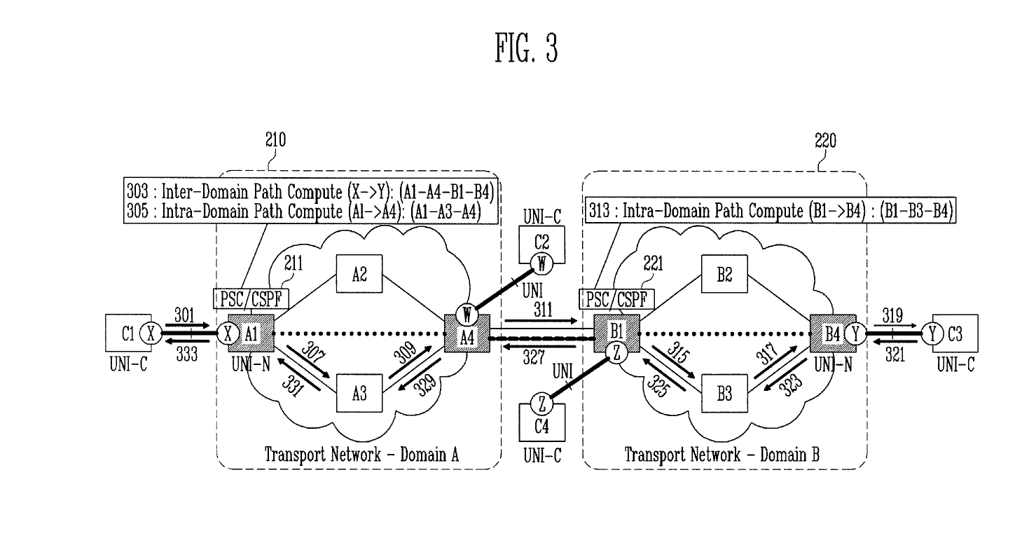

In order to compute and set up a UNI path based on TNA address, abstract TE links must be configured in a full mesh or partial mesh format between border nodes (that is, network nodes positioned in borders) in advance as illustrated in FIG. 2. Herein, the configured abstract TE links are advertised in a local domain or between domains through an E-NNI routing function.

FIG. 2 is an exemplary view of a network for computing and setting up a TNA address based UNI path.

FIG. 2 illustrates transport networks (210, 220) having two hierarchical routing structures of two domains (A. B) for convenience of explanation.

A first transport network (210) domain A includes four network nodes (A1, A2, A3, A4). Herein, network node (A1) has a TNA address of X, and network (A4) has a TNA address of W.

A second transport network 220 domain B includes four network nodes (B1, B2, B3, B4). Herein, network node (B1) has a TNA structure of Z, and network (B4) has a TNA address of Y.

Herein, the network nodes (A1-A4, B1-B4) include Generalized Multi-Protocol Label Switching (hereinafter referred to as GMPLS′) control plane functions (for example, signaling and routing etc.).

Each of the client nodes (C1-C4) may be connected to network nodes (A1, A4, B1, B4), respectively, and selectively include a UNI-C function. Herein, the client node (C1) has a TNA address of X, the client node (C2) has a TNA address of W, the client node (C3) has a TNA address of Y, and the client node (C4) has a TNA address of Z.

Abstract TE links are formed between the network node (A1) and network node (A4), and between network node (B1) and network (B4) that are border nodes. Inter-domain TE links are formed between the network node (A4) and the network node (B1).

Meanwhile, in domain A, a data link (data bearing link) and TE link are formed between the network node (A1) and the network node (A2), between the network node (A1) and the network node (A3), between the network node (A2) and the network node (A4), and between the network node (A3) and the network node (A4). Furthermore, in domain B, a data link (data bearing link) and TE link are formed between the network node (B1) and the network node (B2), between the network node (B1) and the network node (B3), between the network node (B2) and the network node (B4), and between the network node (B3) and the network node (B4).

In each of the network nodes (A1-A4) of domain A and the network nodes (B1-B4) of domain B, an Interior Gateway Protocol (IGP)(for example, an Open Shortest Path First (hereinafter referred to as ‘OSPF’)-TE) routing protocol operates.

In each of the network nodes (A1, A4, B1, B4) that are border nodes, an External Network-Network Interface (E-NNI) routing protocol (for example, OSPF-TE) for inter-domain operates.

The TE link in each domain is advertised in the local domain through the IGP routing protocol. The TNA addresses and abstract TE links of each domain and inter-domain TE links are advertised in the local domain and between domains through the E-NNI routing protocol. For routing information exchange and advertising between the domains, the network node (A1 (or A4)) of domain A and the network node (B4 (or B1)) of domain B are configured as neighbor nodes.

UNI path control methods that use UNI signaling may be classified into Switched Connection (hereinafter referred to as ‘SC’)(IS-UNI) methods and Soft Permanent Connection (hereinafter referred to as ‘SPC’)(IS-SPC) methods depending on whether or not there is and there is used a UNI signaling function (UNI-C function) in a subscriber device (for example, router or switch etc.) at the end. The SC method and SPC method are defined in the automated transport network control plane structure of ITU-T.

The SC(IS-UNI) method is the method used when there is and is used a UNI-C function in the client nodes (C1-C4), that is the end subscriber device (router or switch). For example, the SC method is used for setting up or unsetting the UNI path (UNI-C to UNI-C) from a source UNI-C (client node (C1)) to a destination UNI-C (client node (C2, C3 or C4)) based on a source TNA address and destination TNA address.

Unlike the SC method, the SPC method (IC-SPC) is a method used when there is no UNI-C function in the client nodes (C1-C4), that is the end subscriber device (router or switch etc.), or when there is a UNI-C function but is not used. For example, the SPC method is used to set up or unset a UNI path (UNI-N to UNI-N) from a source UNI-N (network node (A1)) to a destination UNI-N (network node (A4 or B4)) based on the source TNA address and destination TNA address.

FIG. 3 is an exemplary view of setting up a UNI path using the SC method in the network of FIG. 2.

Referring to FIG. 3, to compute and set up a TNA address based UNI path, the network node (A1) uses two Constraint-based Shortest Path First (hereinafter referred to as ‘CSPF’), that is an intra-domain CSPF and an inter-domain CSPF.

Herein, it is possible to set up a UNI path from X(UNI-C) which is the TNA address of the client node (C1) to Y(UNI-C) which is the TNA address of the client node (C3) using the SC method.

Herein, the client node (C1) transmits a UNI signaling (RSVP-TE path) message to the network node (A1) (step 301).

The network node (A1) performs path computation twice sequentially using a first Path Selection Component (hereinafter referred to as ‘PSC’)/CSPF (211).

Herein, the network node (A1) computes an inter-domain path (A1-A4-B1-B4) for confirming whether or not there is a path reachable at an inter-domain level (E-NNI level) based the abstract TE link and inter-domain TE link up to the destination TNA address (Y) using the inter-domain CSPF (step 303).

Next, the network node (A1) computes a path of the local domain (intra-domain) based on the result of path computation (A1-A4-B1-B4) of step 303 using the intra-domain CSPF (step 305). That is, the network node (A1) computes a path of the TE link level (IGP level) from the network node (A1) that is an ingress node of the local domain (domain A) to the network node (A4) that is an egress node.

Through the aforementioned, the network node (A1) obtains an explicit path (A1-A3-B1-B4) that has been updated from the result of computation of the path of the inter-domain level of step 303 to the result of computation of the path of the local domain of step 305. Meanwhile, although the computed explicit path includes path information consisting of nodes and TE link IDs, only node information is illustrated for convenience of explanation.

When path computation is completed at the network node (A1), the UNI signaling (RSVP-TE path) message is transmitted from the network node (A1) to the network node (B1) based on the computed explicit path (steps 307, 309, and 311).

The network node (B1) performs path computation using a second PSC/CSPF (221). Herein, the network node (B1) computes a path (B1-B3-B4) for the local domain (domain B) using the intra-domain CSPF (step 313).

When the path computation is completed at the network node (B1), the UNI signaling (RSVP-TE path) message is transmitted from the network node (B1) to the client node (C3) based on the computed explicit path (steps 315, 317, and 319).

Then, the client node (C3) and network nodes (B4, B3, B1, A4, A3, A1) transmit the UNI signaling (RSVP-TE Resv) message to the client node (C1) direction in a reverse direction to the direction of receiving the UNI signaling (RSVP-TE path) message (steps 321, 323, 325, 327, 329, 311, and 333). Through the aforementioned, when the UNI signaling is completed, the UNI path is set up.

As such, the RSVP-TE signaling may be used as the UNI signaling for setting up the UNI path. Herein, since setting up a path (LSP) with the explicit path information through the RSVP-TE signaling is a unique function of the RSVP-TE, further explanation is omitted.

For reference, the client node (C1) may receive a request for setting up a UNI path. A Network Monitoring System (hereinafter referred to as ‘NMS’) and a Command Line Interface (hereinafter referred to as ‘CLI’) may be used in the request for setting up a UNI path. A UNI path set up request of the SC method (IS-UNI) includes detailed parameters for setting up a UNI. For example, the detailed parameters may include an Ingress LSR ID=0, Egress LSR ID=0, switching type, encoding type, direction, Quality of Service (QoS) parameter, source TNA address and type, destination TNA address and type, service level, and Call ID etc. At the client node (C1), after a Next Hop Routing (NHR) query based on the destination TNA address, the UNI signaling (RSVP-TE path) message is transmitted to the next hop (for example, step 301). Furthermore, the same is applied to the network node (B4) (for example, step 319).

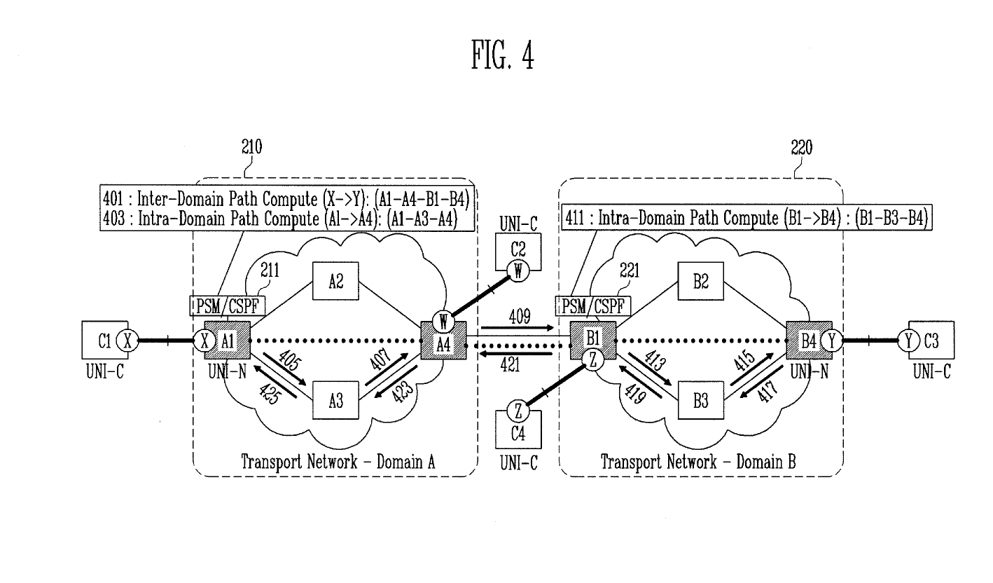

FIG. 4 is an exemplary view of setting up a UNI path using the SPC method in the network of FIG. 2. Referring to FIG. 4, everything is the same as in FIG. 3 except for the UNI path control method, and thus FIG. 3 will be referred to for explanation on FIG. 4.

Herein, the network node (A1) may receive a UNI path set up request. An NMS and CLI may be used in the UNI path set up request. The UNI path set up request of the SPC method (IS-SPC) includes detailed parameters for setting up the UNI. For example, the detailed parameters may further include a label port and label port information in comparison to the detailed parameters of the SC method (IS-UNI).

As such, the UNI path is a path set up between ends (network nodes or client nodes) based on the TNA address between ends, and to compute and set up a UNI path, abstract TE links must be configured between the border nodes in a full mesh or partial mesh format. As such, for a UNI path set up, an overhead increases due to routing information exchange and advertisements in the network.

For this purpose, in the present disclosure, a Path Computation Element (hereinafter referred to as ‘PCE’) may be used. The PCE may be defined as a Head-End Node (HEN), that is, a functional block included in a Label Edge Router (LER) mode or a functional block included in a Network Management System (NMS). Such a PCE may be separated and operated as an external PCE for reduction of load of the network node and due to expansion of additional functions. The PCE computes an optimal path based on a Traffic Engineering Database (hereinafter referred to as ‘TED’) at a request by a Path Computation Client (hereinafter referred to as ‘PCC’)(or another PCE). That is, the PCE uses network topology and resource information included in the TED in computing the path.

Communication between a PCE and a PCC or between a PCE and another PCE is made using the Path Computation Element Protocol (PCEP).

FIG. 5 is a view illustrating a path computation element and a network where TNA address is advertised between domains.

Referring to FIG. 5, transport networks (510, 520) having two domains (A, B) and two hierarchical routing structure are illustrated for convenience of explanation.

Domain A of the first transport network (510) includes four network nodes (A1, A2, A3, A4). Herein, the network node (A1) has a TNA address of X, and the network node (A4) has a TNA address of W.

Domain B of the second transport network (520) includes four network nodes (B1, B2, B3, B4). Herein, the network node (B1) has a TNA address of Z, and the network node (B4) has a network address of Y.

Herein, the network nodes (A1-A4, B1-B4) include GMPLS control plane functions (for example, signaling and routing etc.).

Herein, as external PCEs (511, 521) are used, abstract TE links between the network nodes (A1-A4, B1-B4) are not configured in a full mesh or partial mesh format. By this configuration, the overhead of configuring and managing an abstract TE link and the advertisement overhead of the abstract TE link in the local domain (or inter-domain) is removed.

The client nodes (C1-C4) may selectively include a UNI-C function. Herein, the client node C1 has a TNA address of X, the client node (C2) has a TNA address of W, the client node (C3) has a TNA address of Y, and the client node (C4) has a TNA address of Z.

Therefore, only the TNA addresses are advertised in the local domain or between domains. Inter-domain TE links may be or may not be advertised between domains. In a case where an inter-domain TE link is advertised between domains, inter-domain TE link information are used for domain sequence computation. On the other hand, in a case where an inter-domain TE link is not advertised between domains, an inter-domain path that goes through multi domains are computed based on a predetermined domain order. For computation of the domain order, the inter-domain TE link may be advertised between domains.

FIG. 6 is an exemplary view of setting up a UNI path using the SC method in the network of FIG. 5.

Referring to FIG. 6, for UNI path computation, an inter-PCE based path computation method is used. Herein, the UNI path may be set up using the SC method from X(UNI-C) that is the TNA address of the client node (C1) to Y(UNI-C) that is the TNA address of the client node (C3).

The client node (C1) transmits a UNI signaling (RSVP-TE Path) message to the network node (A1) (step 601).

The network node (A1) computes the path through PCC (512). Herein, the PCC (512) is a PCE-A (511) that manages the local domain. It requests for path computation from the source TNA address (X) to destination TNA address (Y) (step 603).

The PCE-A (511) converts the source TAN address (X) into a source node address (A1), and converts the destination TNA address (Y) into a destination node address (B4). For example, the source node address and the destination node address may be a Label Switch Router ID (hereinafter referred to as ‘LSR ID’). Herein, for the LSR ID, a value that is the same as the router ID or TE router ID may be used. Otherwise, the LSR ID may be the router ID or the TE router ID.

The converted destination node address (B4) is not included in the local domain (domain A) that the PCE-A (511) manages. Therefore, the PCE-A (511) computes the UNI path (that is, the TE path that satisfies the path computation request) that goes through multi domains in an interlocked manner with the PCE-B (521) (step 605).

Herein, the PCE-B (521) that received the path computation request from the PCE-A (511) performs path computation, and transmits a result of the path computation (B1-B3-B4) to the PCE-A (511) (step 607).

The PCE-A (511) that received the result of the path computation performs path computation for the local domain (domain A) based on the received result of path computation, and then transmits a final path computation result (A1-A3-A4-B1-B3-B4) to the PCC (512) based on the received result of path computation and the computed result of path computation (step 609).

The path computation at steps (603 to 609) may internally use a Backward Path Computation or Backward Recursive PCE-based Computation (hereinafter referred to as ‘BRPC’).

When the path computation procedure succeeds, the computed Explicit Route Object (ERO)(A1-A3-A4-B1-B3-B4) are route information consisting of a node, TE link and ID, but for convenience of explanation they are shown as only node information.

Through the aforementioned, the network nodes (A1, A3, A4, B1, B3, B4) sequentially transmit a UNI signaling (RVSP-TE path) message (steps 611, 613, 615, 617, 619).

The network node (B4) that received the UNI signaling (RSVP-TE Path) message transmits the UNI signaling (RSVP-TE Path) message to the client node (C3) (step 621). Then, the UNI signaling (RSVP-TE Resv) message is transmitted to the network node (A1) direction in a reverse direction to the direction of receiving the UNI signaling (RSVP-TE Path) message (steps 625, 627, 629, 631, and 633).

The network node (A1) that received the UNI signaling (RSVP-TE Resv) message transmits the UNI signaling message to the client node (C1) (step 635). Through the aforementioned, when the UNI signaling is completed, the UNI path is set up.

For reference, the client node (C1) may receive the UNI path set up request. For the UNI path set up request, an NMS and CLI may be used. The UNI path set up request of the SC method (IS-UNI) includes detailed parameters for setting up the UNI. For example, the detailed parameters may include an Ingress LSR ID=0, Engress LSR ID=0, switching type, encoding type, direction, QoS parameter, source TNA address and type, destination TNA address and type, service level, and Call ID and the like. In the client node (C1), after the next hop routing (NHR) query based on the destination TNA address, the UNI signaling (RSVP-TE Path) message is transmitted to the next hop (for example, step 601). Furthermore, the same applies to the network node (B4) (for example, step 621).

FIG. 7 is an exemplary view of setting up a UNI path using the SPC method in the network illustrated in FIG. 5.

Referring to FIG. 7, everything is the same as FIG. 6 except for the UNI path control method, and thus FIG. 6 will be referred to for explanation on FIG. 7.

For reference, the network node (A1) may receive the UNI route set up request. For the UNI set up request, an NMS. CLI and the like may be used. The UNI path set up request of the SPC method (IS-SPC) includes detailed parameters for setting up the UNI. For example, the detailed parameters may include an Ingress LSR ID=0, Egress LSR ID=0, switching type, encoding type, direction, QoS parameter, source TNA address and type, destination TNA address and type, service level, Call ID, label port, and label-related information.

FIG. 8 is a view illustrating a path computation element and a network where TNA addresses between domains are not advertised according to an embodiment of the present disclosure.

Referring to FIG. 8, for convenience of explanation, transport networks (810, 820) having two domains (A, B) and two hierarchical routing structure are illustrated. The networks of FIG. 8 is different from the networks of FIG. 5 in that they do not advertise TNA address between domains due to the confidentiality, expandability, and protocol compatibility and the like. That is, the TNA address is advertised only in the local domain.

Therefore, for explanation on the network structure of FIG. 8, the explanation on the network structure of FIG. 5 will be referred to.

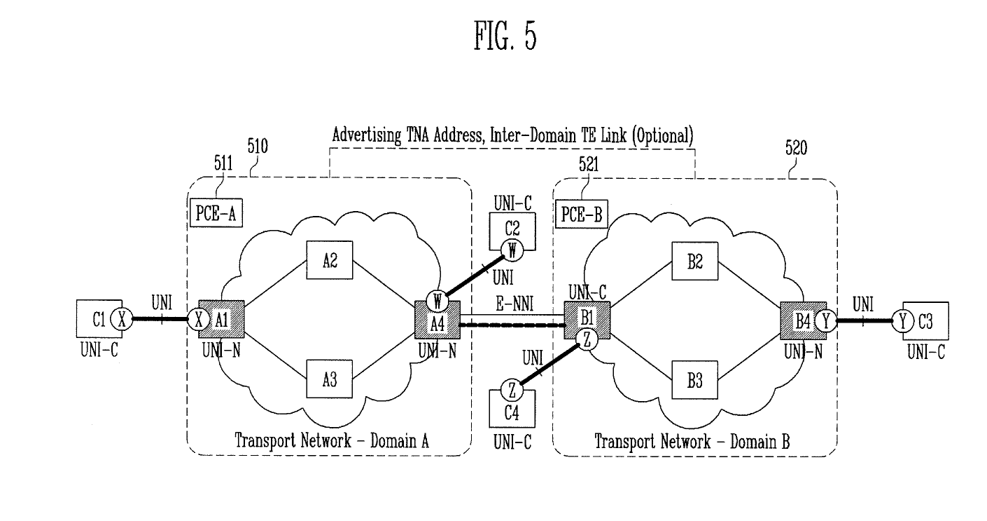

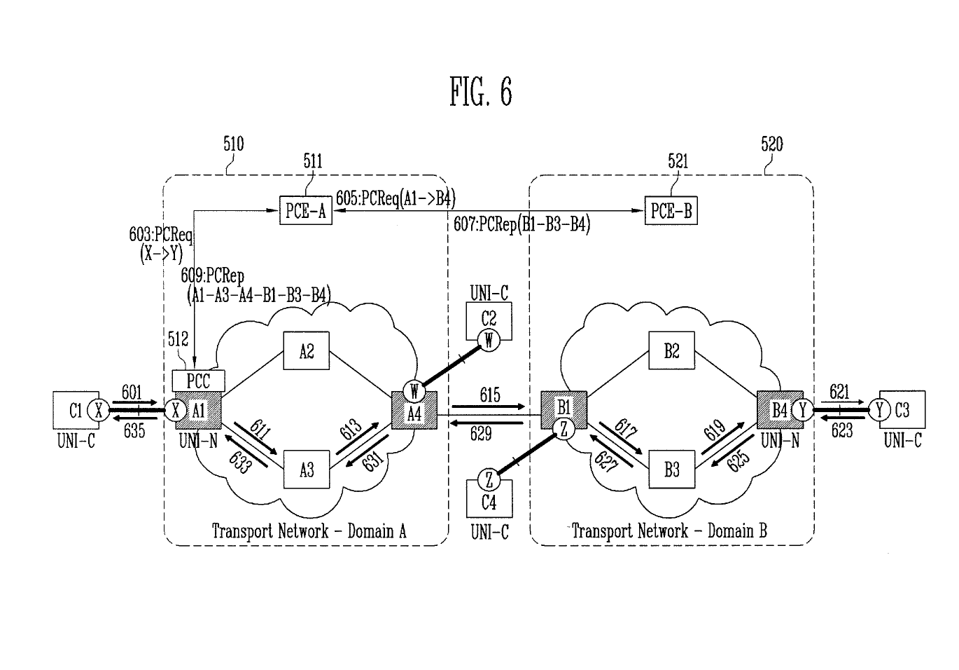

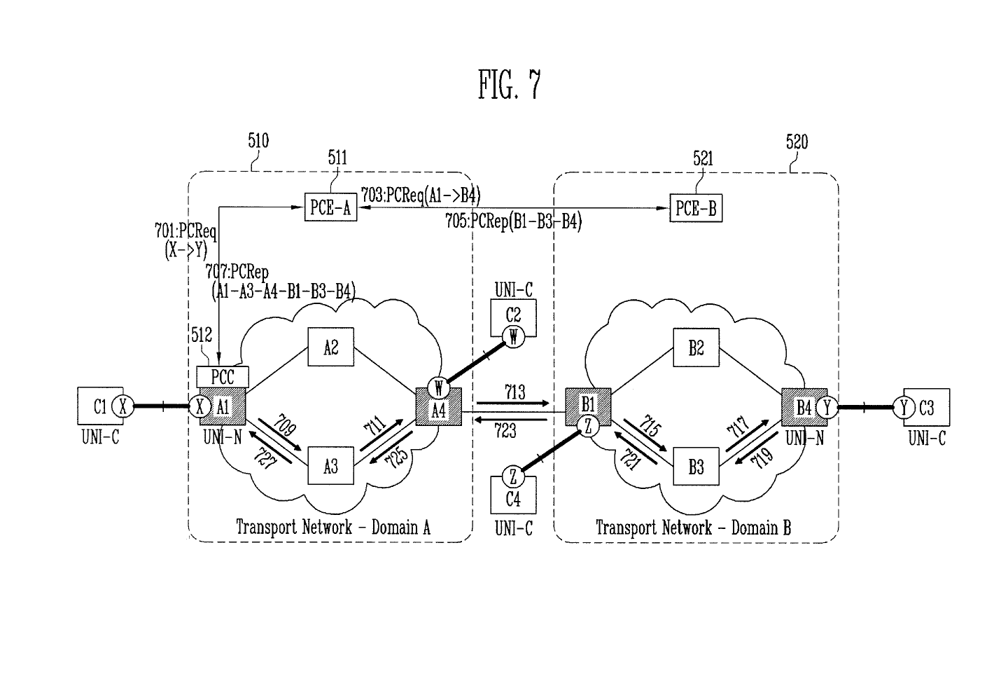

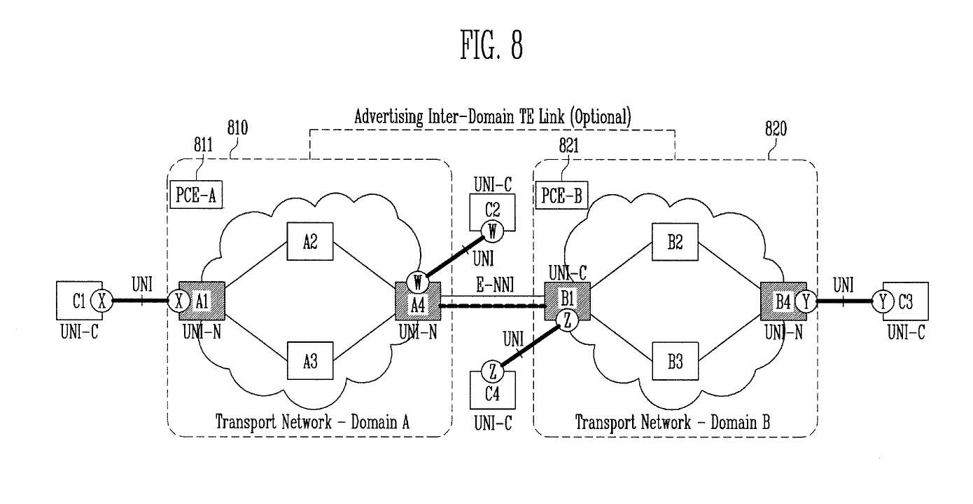

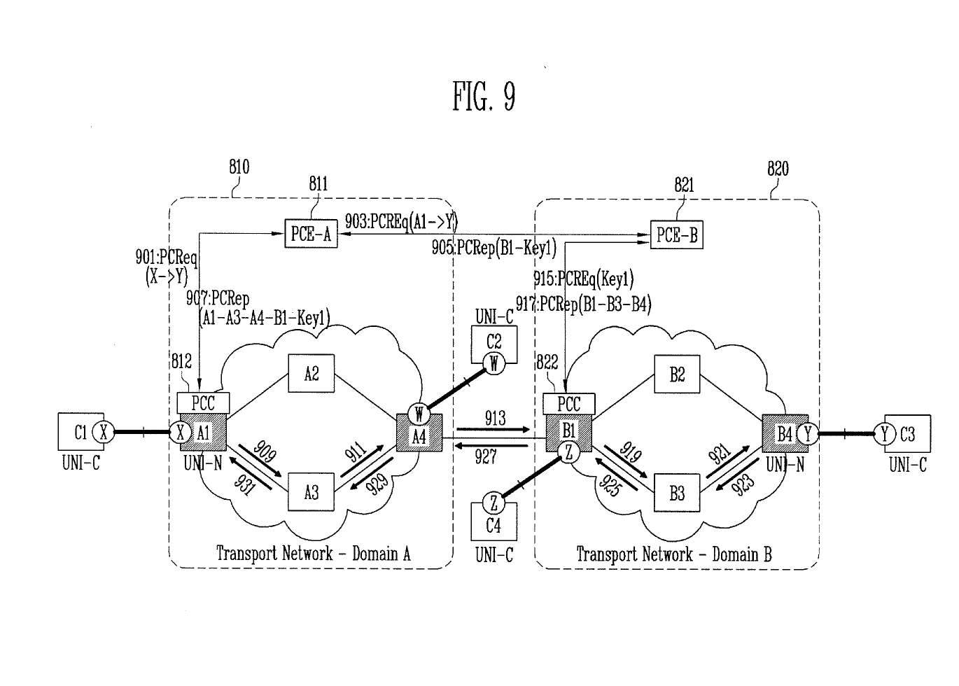

FIG. 9 is an exemplary view of setting up a UNI path using the SPC method in the network illustrated in FIG. 8.

Referring to FIG. 9, for UNI path computation, a path-key based path computation method is used. Herein, the UNI path may be set up using the SPC method from the X(UNI-N) that is the TNA address of the network node (A1) to the Y(UNI-N) that is the TNA address of the network node (B4).

The network node (A1) computes the path using the PCC (812). Herein, the PCC (812) requests the PCE-A (811) that manages the local domain to compute the path from the source TNA address (X) to the destination TNA address (Y) (step 901).

The PCE-A (811) converts the source TNA address (X) into a source node address (A1), but cannot convert the destination TNA address (Y) into the destination node address since the TNA addresses are not advertised between the domains. The PCE-A (811) uses the converted source node address (A1) and destination TNA address (Y). For example, the source node address and the destination node address may be LSR ID.

The destination TNA address (Y) is not included in the local domain (domain A) that manages the PCE-A (811). Therefore, the PCE-A (811) computes the UNI path that goes through multi domains (that is the TE path that satisfies the path computation request) in an interlocked manner with the PCE-B (821).

For this purpose, the PCE-A (811) transmits the path computation request (PCReq(A1->Y)) message that includes the source node address (A1) and destination node address (Y) to the PCE-B (821) (step 903).

Herein, the PCE-B (821) that received the path computation request from the PCE-A (811) converts the destination TNA address (Y) into a destination node address (B4) to perform path computation (B1-B3-B4), and transmits the path computation result (B1-Key1) (that is, a path computation response (PCRep) message) that includes the path-key to the PCE-A (811) based on the path computation (step 905).

The PCE-A (811) that received the path computation result performs path computation regarding the local domain (domain A) based on the received path computation result, and transmits a final path computation result (A1-A3-A4-B1-Key1) to the PCC (812) of the network node (A1) based on the path computation result received from the PCE-B (821) and the path computation result (A1-A3-A4) computed in the local domain (domain A) (step 907).

When the path computation procedure succeeds, the computed explicit route object (ERO)(A1-A3-A4-B1-Key1) are the path information consisting of a node, TE link ID, and path-key, and for convenience of explanation, only the node information and path key information are shown.

Through the aforementioned, the network nodes (A1, A3, A4) sequentially transmits the UNI signaling (RSVP-TE Path) message (steps 909, 911, 913).

The network node (B1) that received the UNI signaling (RSVP-TE Path) message incorporates the path-key information (Key1) included in the received ERO into the path computation request (PCREq) message using the PCC (822) and requests the PCE-B (821) that manages the local domain to perform path computation (step 915).

When the PCE-B (821) receives the path computation request, the PCE-B (821) transmits the path computation response (PCRep, B1-B3-B4) message that is based on the path key information (Key 1) to the PCC (822) (step 917).

The network node (B1) that received the path computation result (B1-B3-B4) through the PCC (822) transmits the UNI signaling (RSVP-TE Path) message to the network node (B3) (step 919), and the network node (B3) transmits the UNI signaling message to the network node (B4) (step 921).

Then, the network nodes (B4, B3, B1, A4, A3, A1) transmit the UNI signaling (RSVP-TE Resv) message to the network node (A1) direction in a reverse direction of receiving the UNI signaling (RSVP-TE Path) message (steps 923, 925, 927, 929, 931). Through the aforementioned, when the UNI signaling is completed, the UNI path is set up.

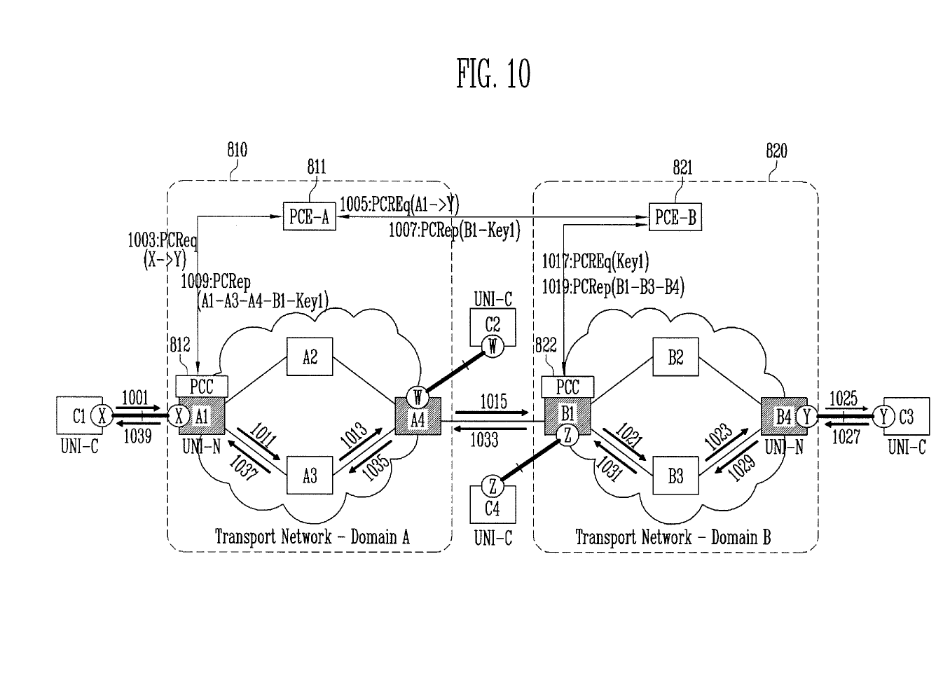

FIG. 10 is an exemplary view of setting up a UNI path using the SC method in the network illustrated in FIG. 8.

Referring to FIG. 10, for UNI path computation, a path-key based path computation method is used. Herein, a UNI path may be set up from X(UNI-C) that is the TNA address of the client node (C1) to Y(UNI-C) that is the TNA address of the client node (C3). Everything is the same as in FIG. 9 except for the UNI path control method, and thus explanation on FIG. 9 will be referred to for the explanation on FIG. 10.

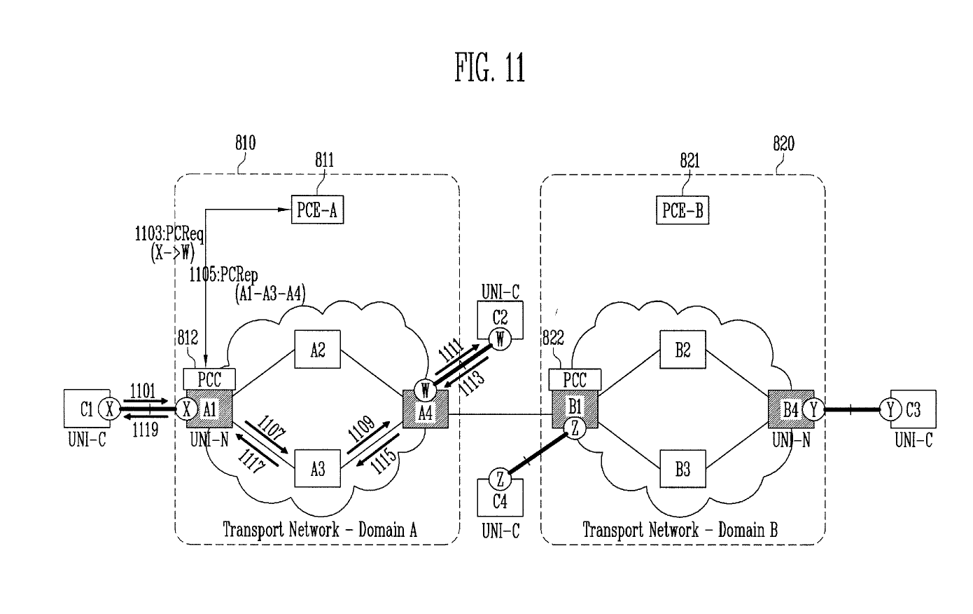

FIG. 11 is an exemplary view of setting up a UNI path in a single domain using the SC method in the network illustrated in FIG. 8.

Referring to FIG. 11, when the source TNA address and destination TNA address belong to a local domain, the UNI path may be set up in a single domain. Herein, the UNI path may be set up from the X(UNI-C) that is the TNA address of the client node (C1) to W(UNI-C), that is the TNA address of the client node (C2) using the SC method. Herein, the operation of setting up the UNI path may be applied to both cases where the TNA address is advertised between domains and where the TNA address is not advertised between domains.

The client node (C1) transmits the UNI signaling (RSVP-TE Path) message to the network node (A1) (step 1101).

The network node (A1) computes the path through the PCC (812). Herein, the PCC (812) requests the PCE-A (811) that manages the local domain to compute the path from the source TNA address (X) to the destination TNA address (W) (transmitting a path computation request(PCReq(X->W) message) (step 1103).

The PCE-A (811) converts the source TNA address (X) into a source node address (A1), and converts the destination TNA address (W) into a destination node address (A4). For example, the source node address and destination node address may be LSR ID.

The PCE-A (811) computes a UNI path (that is a TE path that satisfies the path computation request) corresponding to the path computation request from the source node address (A1) to the destination node address (A4) based on the converted address. The PCE-A (811) transmits a result of the path computation, that is, a path computation response (PCRep)(A1-A3-A4) message to the PCC (812) (step 1105).

When the path computation procedure succeeds, the ERO (A1-A3-A4) are path information consisting of a node and TE link ID, and for convenience of explanation, only the node information are shown.

Through the aforementioned, the network nodes (A1, A3) sequentially transmit the UNI signaling (RSVP-TE Path) message (steps 1107, 1109).

The network node A4 that received the UNI signaling (RSVP-TE Path) message transmits the UNI signaling (RSVP-TE Path) message to the client node (C2) (step 1111).

Then, the client node (C2) and the network nodes (A4. A3, A1) transmit the UNI signaling (RSVP-TE Resv) message to the client node (C1) direction in a reverse direction of receiving the UNI signaling (RSVP-TE Path) message (steps 1113, 1115, 1117, 1119). Through the aforementioned, when the UNI signaling is completed, the UNI path is set up.

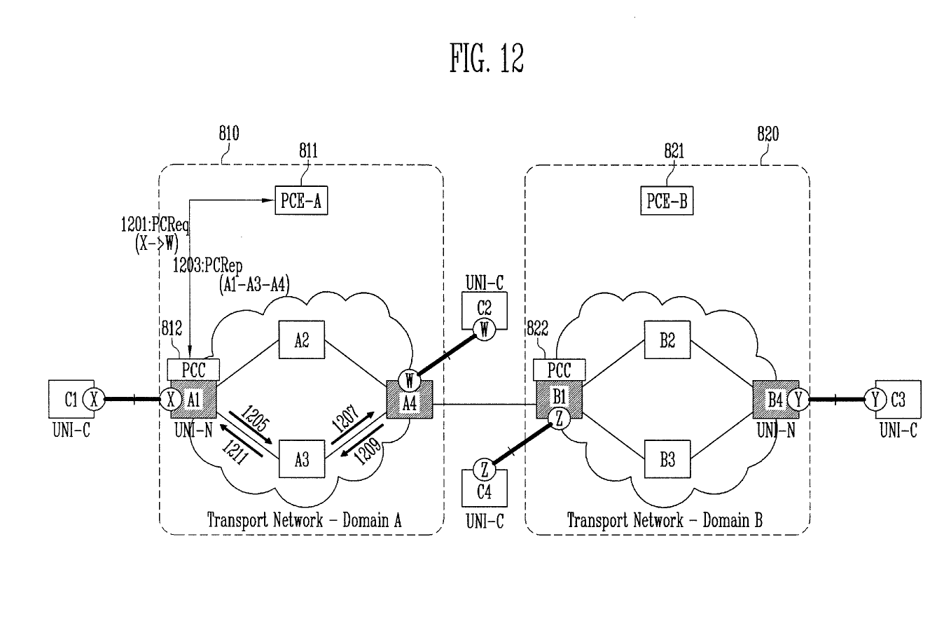

FIG. 12 is an exemplary view of setting up a UNI path in a single domain using the SPC method in the network illustrated in FIG. 8.

Referring to FIG. 12, when the source TNA address and the destination TNA address belong to a local domain, the UNI path may be set up in a single domain. Herein, the UNI path may be set up from the X(UNI-N) that is the TAN address of the network node (A1) to the W(UNI-N) that is the TNA address of the network node (A4) using the SPC method. Herein, the operation of setting up the UNI path may be applied to both cases where the TNA address is advertised between domains and where the TNA address is not advertised between the domains.

Since everything is the same as in FIG. 11 except for the UNI path control method, explanation on FIG. 11 will be referred to for the explanation on FIG. 12.

FIG. 13 is view illustrating a path computation element according to an embodiment of the present disclosure.

Referring to FIG. 13, the path computation element (PCE)(1300) includes an information collection and management unit (1310), a plurality of databases (1320, 1330, 1340, 1350), and an engine unit (1360).

Herein, the plurality of databases (1320, 1330, 1340, 1350) include a Traffic Engineering Database (TEDB)(1320), Domain Sequence Database (DSBD)(1330), TNA Address Database (1340), and Policy Database (PDB)(1350).

The information collection and management unit (1310) collects network topology and resource information, information related to the domain sequence, and information related to TNA address that are required for computing a path, and stores the collected information in the plurality of databases (1320, 1330, 1340, 1350) or updates the same. The information collection and management unit (1310) may receive an OSPF LS (Link State) update message that includes an IGP and E-NNI routing protocol messages (for example, Opaque Area LSA (Link State Advertisement)).

Furthermore, the information collection and management unit (1310) collects the information to be stored in the Traffic Engineering Database (1320) and the Domain Sequence Database (1330) from Sub-TLV included in the IGP and OSPF Opaque Area LSA of the E-NNI, and collects the information related to the TNA address from the Node Attribute TLV included in the OSPF Opaque Area LSA of the E-NNI or the Transport Network Address TLV.

The information collection and management unit (1310) may collect related information using various methods besides the routing protocol interlock operation. For example, the information collection and management unit (1310) may use a CLI/Simple Network Management Protocol or NetConf (Network Configuration) protocol, or may be mutually interlocked with an NMS/Element Management System, or Path Control Management System and the like. Furthermore, the information collection and management unit (1310) may directly receive related information from an operator.

The Traffic Engineering Database (1320) may store network topology and resource information of the IGP level of the local domain (for example, TE topology information, state information of TE link, switching type, encoding type, total bandwidth, bandwidth in use, available bandwidth, and metric and the like).

The Domain Sequence Database (1330) stores information related to the domain sequence (order). In a case where the inter-domain TE link is being advertised between the domains, the Domain Sequence Database (1330) stores information on the domain sequence that includes the inter-domain TE link information of the E-NNI level (for example, information on the border node that connects the domains and the link information therebetween). When the inter-domain TE link is not being advertised between the domains, the Domain Sequence Database (1130) stores information on the domain sequence according to a predetermined policy.

The TNA Address Database (1340) includes information that enables mapping a TNA address to a node address.

The policy database (1350) stores policy information for path setting up. The policy database (1350) includes information on an inter-domain routing policy and inter-domain path computation policy. The inter-domain routing policy information includes information on a path computation method that is being used or may be used internally, and information on a path computation method available according to an inter-domain routing policy. Herein, a backward path computation method, BRPC method, and path-key based computation method may be used as the path computation method. For example, in FIGS. 6 and 7, the backward path computation method or BRPC method was used, and in FIGS. 9 and 10, the path-key based path computation method was used.

The engine unit (1360) computes an optimal path corresponding to the path computation request (PCReq) message received from the PCC (or another PCE)(1301). When the path computation is completed, the engine unit (1360) transmits the path computation response (PCrep) message that includes the path computation result to the PCC (or another PCE)(1301) that requested the path computation. Meanwhile, when a mutual interlocked operation with another PCE is necessary, the engine unit (1360) may perform the role of the PCC.

When the source address and the destination address included in the PCReq message received from the PCC (1301) are TNA addresses, the engine unit (1360) converts the source TNA address and the destination TNA address into a source node address and a destination node address using the TNA address database (1340). Herein, the source node address and destination node address are LSR ID. Then, the engine unit (1360) computes an optimal path with the converted source node address and the destination node address based on the Traffic Engineering Database (1320). Herein, in the engine unit (1360), the path computation method may be determined based on the policy database (1350), and the domain order may be determined by the domain sequence database (1330).

Furthermore, the engine unit (1360) may compute not only a TNA address based UNI path but also an optimal path regarding NNI-to-NNI between end nodes (from Head-End Node to Tail-End Node) based on various endpoints (for example, IPv4, IPv6, and Unnumbered Interface).

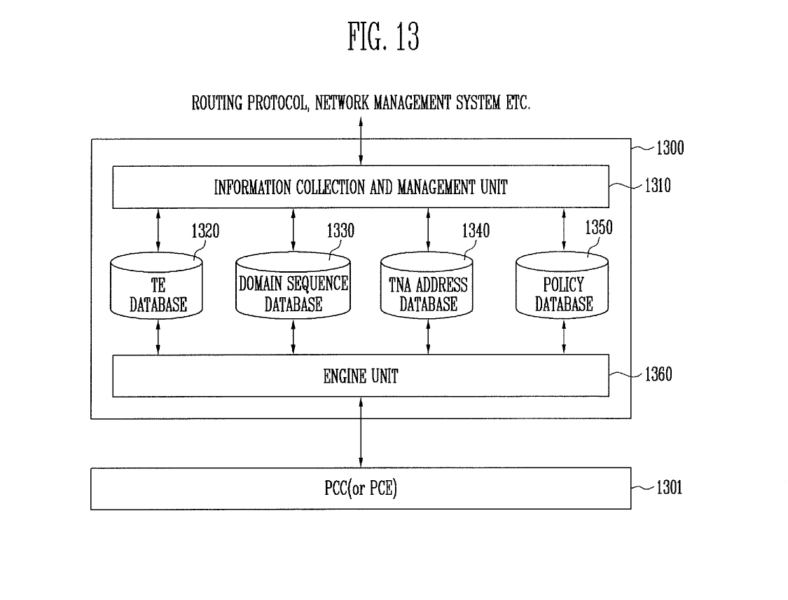

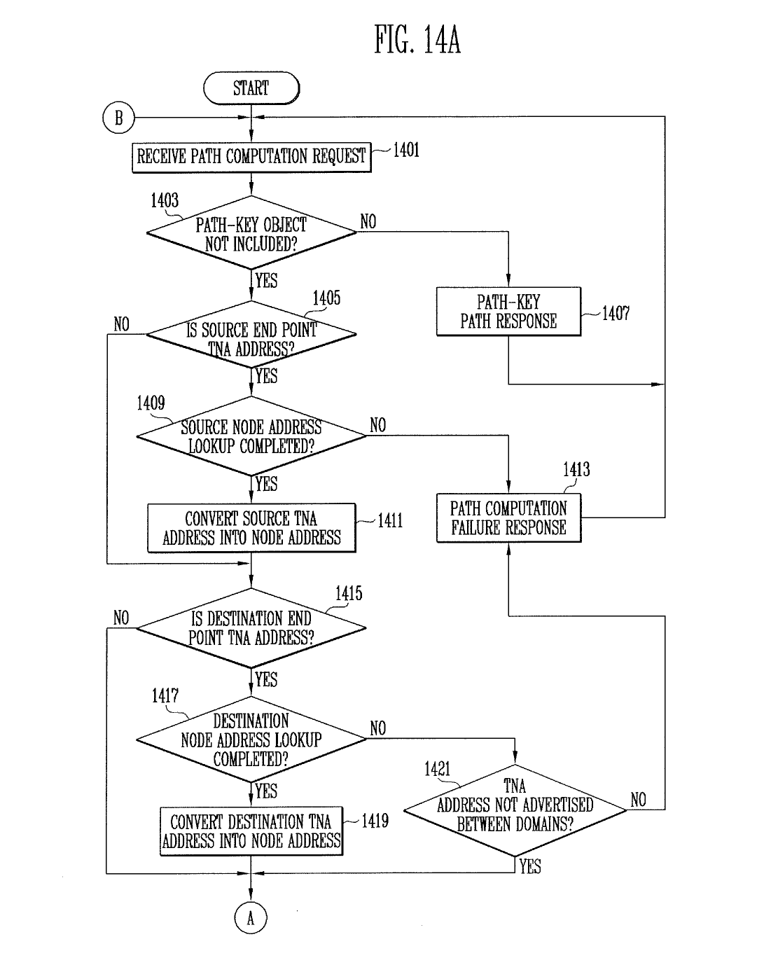

In such a PCE (1300), when the source address and destination address included in the PCReq message received from the PCC (or PCE) are TNA addresses, the TNA addresses are converted into source node addresses (LSR ID) and destination node addresses (LSR ID) based on the database. Hereinbelow, the operation of performing path computation according to the inter-domain path computation policy will be explained with reference to FIG. 14.

FIGS. 14A and 14B are flowcharts of a path computation method of a path computation element according to an embodiment of the present disclosure.

Referring to FIG. 14A, the PCE (1300) receives a path computation request from the PCC (or another PCE)(1300) (step 1401).

The PCE (1300) confirms whether or not a path-key object is included in the path computation request (step 1403).

If the path-key object is not included in the path computation request as a result of confirmation at step 1403, the PCE (1300) proceeds to step 1405.

The PCE (1300) confirms whether or not information on a source endpoint at the path computation request is an TNA address (step 1405).

However, if the path-key object is included in the path computation request as a result of confirmation at step 1403, the PCE (1300) proceeds to step 1407.

The PCE (1300) transmits a path response corresponding to the path-key (step 1407).

If the source endpoint is a TNA address as a result of determination at step 1405, the PCE (1300) proceeds to step 1409.

The PCE (1300) performs a source node address lookup, and determines whether or not the source node address lookup is completed (step 1409). The source node address lookup may be performed using the TNA address database (1340).

If it is determined at step 1409 that the source node address lookup is completed, the PCE (1300) proceeds to step 1411.

The PCE (1300) converts the source TNA address to the source node address (LSR ID) through the source node address lookup, and proceeds to step 1415 (step 1411).

If it is determined at step 1409 that the source node address lookup is not completed, the PCE (1300) proceeds to step 1413. If there is no source TNA address from the source address lookup in the PCE (1300), it means the path computation has failed.

Since the path computation failed, the PCE (1300) transmits a path computation failure response to the PCC (or PCE)(1301) and proceeds to step 1401 (step 1413).

If it is determined at step 1405 that the source endpoint is not a TNA address, the PCE (1300) proceeds to step 1415. In a case where the TNA address is not included in the endpoint object (for example, when the address value included in the endpoint object is 0(zero), and the TNA address is included in another object), the PCE (1300) refers to the source TNA address of the object where the source TNA address is included.

The PCE (1300) determines whether or not the information on the destination endpoint in response to the path computation request is a TNA address (step 1415).

If it is determined at step 1415 that the destination endpoint is a TNA address, the PCE (1300) proceeds to step 1417.

The PCE (1300) performs a destination node address lookup, and determines whether or not the destination node address lookup is completed (step 1417). The destination node address lookup may be performed using the TNA address database (1340).

If it is determined at step 1417 that the destination node address lookup is completed, the PCE (1300) proceeds to step 1419.

The PCE (1300) converts the destination TNA address into a destination node address (LSR ID) through the destination node address lookup, and proceeds to step 1423 (step 1419).

If it is determined at step 1417 that the destination node address lookup is not completed, the PCE (1300) proceeds to step 1421.

The PCE (1300) determines whether or not the TNA address advertisement is being made between domains (step 1421).

If it is determined at step 1421 that the TNA address advertisement is being bade between domains, the PCE (1300) proceeds to step 1423. However, if it is determined that the TNA address advertisement is not being made between domains, the PCE (1300) proceeds to step 1413.

If it is determined at step 1415 that the destination endpoint is not a TNA address, the PCE (1300) proceeds to step 1423. In a case where the TNA address is not included in the end-point object (for example, when the address value included in the end-point object is 0(zero) and the TNA address is included in another object), the PCE (1300) refers to the destination TNA address of the object where the destination TNA address is included.

Referring to FIG. 14B, the PCE (1300) confirms whether or not the path set up request is for a single domain path computation (step 1423).

If it is determined at step 1423 that the path set up request is for a single domain path computation, the PCE (1300) proceeds to step 1425.

The PCE (1300) performs the single domain path computation and proceeds to step 1433 (step 1425). That is, if the source node address and the destination node address exist in a same domain, a UNI path regarding the single domain is computed using the traffic engineering database (1320).

If it is deter lined at step 1423 that the path set up request is not for a single domain path computation, the PCE (1300) determines whether or not the destination address is in the local domain (step 1427).

If it is determined at step 1427 that the destination is in the local domain, the PCE (1300) proceeds to step 1429.

The PCE (1300) computes the local domain path and proceeds to step 1433 (step 1429). This is a case of the destination domain in the path computation that goes through multi domains. That is, the destination TNA address or destination node address may exist in the local domain. This means that the destination of the PCReq message received from another PCE is located in its local domain. Therefore, the PCE (1300) may compute the path to the destination node in the local domain and transmit a path computation result to the PCE that requested the path computation.

If it is determined at step 1427 that the destination is not in the local domain, the PCE (1300) proceeds to step 1431. This requires mutual interlocked operation with another PCE if the destination TNA address or destination node address is not in the local domain. Furthermore, if the destination of the PCReq message received from another PCE does not belong to its local domain (middle domain), a path computation request is made to another PCE. Through the aforementioned, a response is made to the PCC (or PCE) (1301) that requested the path computation. Herein, the domain order of computing the path may be determined by the domain sequence database (1340), and the path computation method is determined based on the policy database (1350).

The PCE (1300) computes an inter-domain path and proceeds to step 1433.

The PCE (1300) transmits the result of path computation to the PCC (or PCE) (1301) and proceeds to step 1401 (step 1433).

Accordingly, in the present disclosure, a path computation element protocol (hereinafter referred to as ‘PCEP’) is used between the PCC and the PCE. However, there is no way to determine whether the source address and destination address of the end-point object included in the existing PCReq message is a TNA address or a node address (LSR ID).

That is, in the case of a IPv4 or IPv6 type TNA address, the PCEP may incorporate the TNA address into the endpoint object of the PCReq and transmit the same, but it is difficult for the PCE that received the same to distinguish whether the address included in the endpoint object is a TNA address or a node address. For this purpose, the PCE may need an additional unnecessary procedure. Furthermore, there is no way to transmit a TNA address of an NASP type through the PCEP.

Accordingly, the present disclosure includes a method of representing the TNA address through the PCEP and a method of identifying the TNA address without any additional unnecessary procedure in the PCE.

A first method is to expand and use the endpoint object of the PCEP defined in the RFC (5440).

A second method is to expand and use a generalized endpoint object of the expanded PCEP for GMPLS control plane.

A third method is to define and use a new PCEP object that includes the source TNA address and destination TNA address. Furthermore, the source TNA address and destination TNA address may be incorporated into a predefined PCEP and be used.

Hereinafter, the first method will be explained in detail.

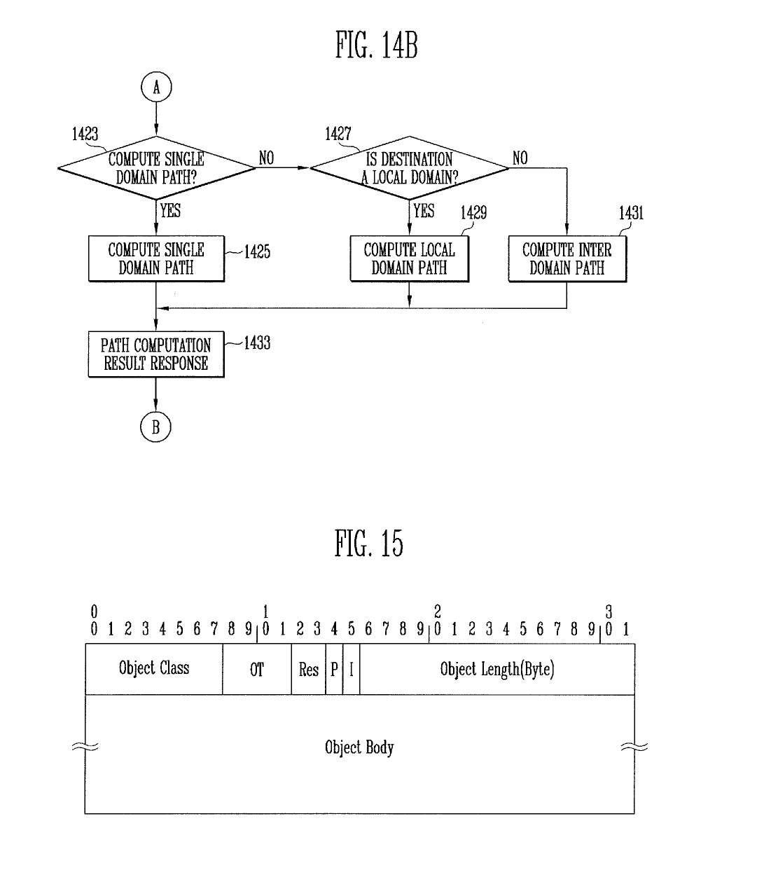

FIG. 15 is a view of a PCEP common object head structure for identifying the TNA address according to the embodiment of the present disclosure.

Referring to FIG. 15, in order to express the source address and destination address as a PCReq message, the PCEP defined in RFC (5440) uses a PCEP common object head and endpoint object. The endpoint object is included as an object body of the PCEP common object head. In order to express and transmit the source TNA address and destination TNA address, three OTs (object types) are additionally defined.

For example, when the OT (object type) has a value of 10 (OT+10), it may represent IPv4 TNA address, and when the OT has a value of 11 (OT=11), it may represent IPv6 TNA address. When the OT has a value of 12 (OT=12), it may represent a NASP TNA address. Herein, for the values of the OT, values that do not overlap with the values being used are used.

Herein, for the object body for the IPv4 address and IPv6 TNA address included in the endpoint object, the object body of the IPv4 address and IPv6 address defined in the PCEP may be used directly. However, an endpoint object body for the NASP TNA address is not defined.

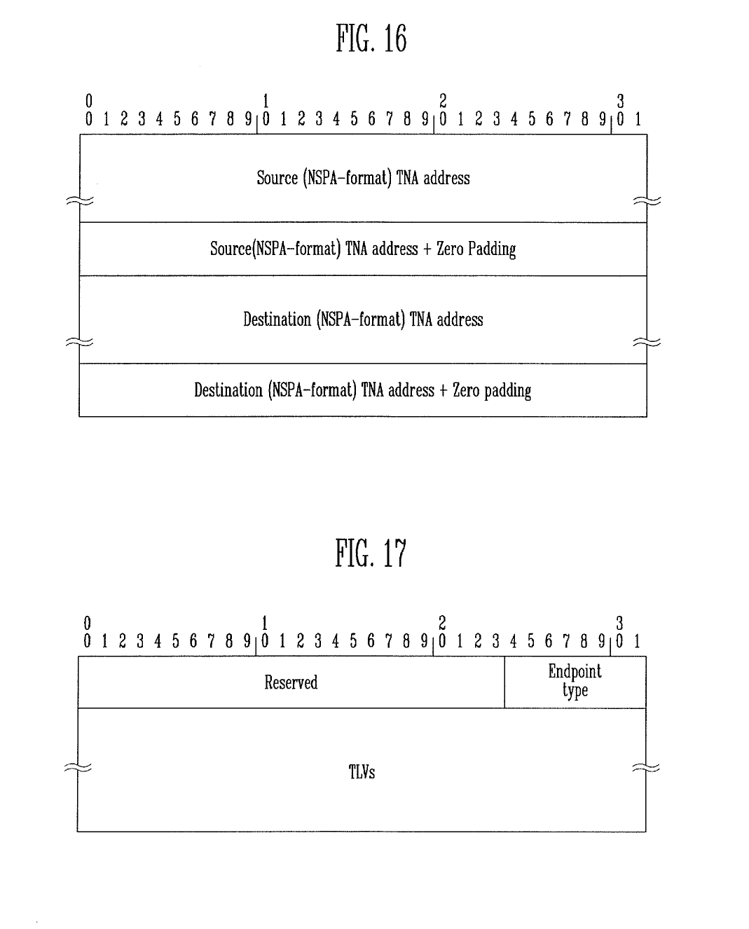

Hereinafter, explanation on the endpoint object body format for the NASP TNA address will be made with reference to FIG. 16.

FIG. 16 is a view illustrating the endpoint object body format for the NASP TNA address according to the embodiment of the present disclosure.

Referring to FIG. 16, the PCReq message of the PCEP defined in the RFC (5440) is included in one endpoint object body together with the source address and destination address. That is, since the source address and destination address included in the endpoint object have the same address type, there may be limitations to usage when the source and the destination have different types of TNA addresses.

Next, hereinbelow, the second method will be explained.

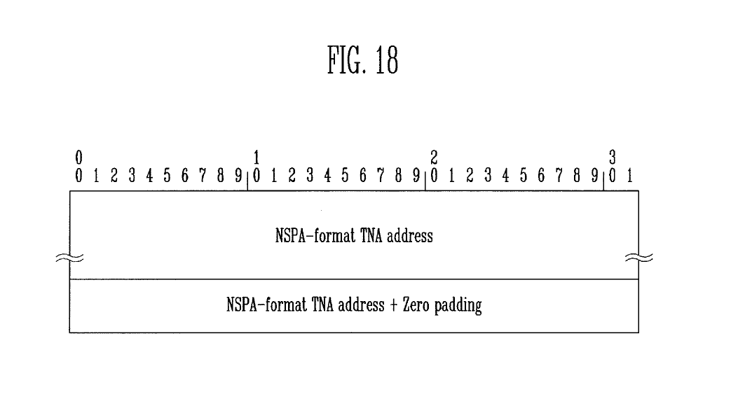

FIG. 17 is a view illustrating a generalized endpoint object for identifying a TNA address according to another embodiment of the present disclosure.

Referring to FIG. 17, the PCEP expanded for GMPLS uses a common object head and a generalized endpoint object in order to express the source address and destination address to the PCReq message. The generalized endpoint object is included as the object body of the PCEP common object head, and the value of the object type (UT) used is 3. The generalized endpoint object has Type Length Values (hereinafter referred to as ‘TLV’) related to point-to-point (endpoint type=0) and end-to-multipoint (endpoint type=1˜4). For example, the TLVs may have formats of a 2 byte type, 2 byte length, and variable value.

In the case of using the generalized endpoint object of the expanded PCEP for GMPLS, three additional endpoint TLV types are defined in order to represent and transmit the source TNA address and destination TNA address (or identify the TNA address and node address).

For example, if the TLV type has a value of 15 (TLV type=15), it may represent IPV4 TNA address, and when the TLV type has a value of 16 (TLV type=16), it may represent IPv6 TNA address, and if the TLV type has a value of 17 (TLV type=17), it may represent a NASP TNA address. Herein, for the values of the OT, values that do not overlap with the values being used are used.

Herein, for the endpoint TLVs for the IPv4 TNA address and IPv6 TNA address included in the TLV, the IPTv4 address and the IPv6 address TLV defined in the PCEP expanded for the GMPLS may be used. However, the endpoint TLV (NASP address TLV) for the NASP TNA address is not defined.

Hereinbelow, the NASP TNA address TLV will be explained with reference to FIG. 18.

FIG. 18 is a view illustrating an NASP TNA address TLV format for the NASP TNA address according to an embodiment of the present disclosure.

The PCReq message expanded for GMPLS control plane uses the source endpoint and destination endpoint, respectively. That is, since the source endpoint and the destination endpoint may have different TLV types, it may also be used when the source and the destination have different types of TNA address.

Next, hereinbelow, the third method will be explained.

A new PCEP object that includes a TNA address (source TNA address or destination TNA address) may be defined and used, or a TNA address may be included in a predefined PCEP object and used.

For example, a new TNA address information ([<TNA-ADDRESS-INFORMATION>]) object may be defined inside a request (<request>) of a PCReq message format, and detailed TVLs or bodies for the TNA address may be defined and used.

Furthermore, detailed TLVs for the TNA address may be defined in a vendor-information object and then used. Using this method, in the object where the source TNA address and destination TNA address are included, the source TNA address and destination TNA address must be referred to. For reference, when the source TNA address and destination TNA address are not included in the endpoint object, that is, when the source TNA address and destination TNA address are included in another object, the address value included in the endpoint object is 0(zero). In the aforementioned present disclosure, the PCEP is used between a PCE and PCC, or between PCEs. Furthermore, for an external PCE based inter-domain path computation, a per-domain based path computation method (RFC 5152), BRPC path computation procedure (RFC 5441), path-key based path computation mechanism (RFC 5520, RFC 5553), and hierarchical PCE based path computation procedure (RFC 6805) and the like may be utilized.

As such, in the TNA address based UNI path computation and UNI path setting up method, there is no need to configure beforehand abstract TE links that must be configured in a full mesh or partial mesh format between border nodes. Thus, even if the size of the network increases, it is possible to minimize the overhead of configuration and management caused by the manual environment set up (abstract TE link) that must be configured beforehand. Furthermore, it is possible to minimize failure of setting up a UNI path caused by an error by the manual environment set up. Furthermore, it is possible to minimize the routing information exchange and advertisement overhead (cost) between local domains and between domains.

Furthermore, it is possible to identify whether or not there is a TNA address without unnecessary procedure in the PCE, and to compute a UNI path according to a routing policy. Therefore, it is possible to compute and set up a TNA based UNI path when the TNA addresses are advertised between domains, and even when the TNA addresses are not advertised between domains due to confidentiality, expandability, and protocol compatibility.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A path computation element comprising:
a plurality of databases configured to store information; and
an engine unit configured, in response to receiving a request to compute a UNI (User Network Interface) path, to compute the path using the plurality of databases according to the request to compute the path and to output a result of computing the path,
wherein the engine unit computes the path by converting a source TNA (Transport Network Assigned) address of a source node into a source node address, converting a destination TNA address of a destination node into a destination node address, and computing the path based on a domain where the destination node is located at the request to compute the path.

2. The element according to claim 1,
wherein the plurality of databases comprise:
a traffic engineering database configured to store network topology and resource information;
a domain sequence database configured to store information on a domain sequence;
a network assigned address database configured to store mapping information of a network assigned address and a node address; and
a policy database configured to store policy information for path computation.

3. The element according to claim 1,
wherein the engine unit determines whether or not the address of the source node and destination node is a TNA address.

4. The element according to claim 1,
wherein the source node address and the destination node address are Label Switch Router IDs (LSR IDs).

5. The element according to claim 4,
wherein the Label Switch Router ID is the same as a router ID or a Traffic Engineering (TE) Router ID, or is the router ID or the Traffic Engineering (TE) Router ID.

6. The element according to claim 4,
wherein the engine unit uses a Path Computation Element Protocol (PCEP) and an expanded PCEP.

7. The element according to claim 6,
wherein the engine unit incorporates the source TNA address and destination TNA address into an endpoint object of a PCEP message and transmits the same when using the PCEP.

8. The element according to claim 6,
wherein the engine unit comprises information for identifying an internet protocol version 4 (IPv4) TNA address, internet protocol version 6 (IPv6) TNA address, and NASP TNA address in order to distinguish between the TNA address and node address in an Object Type (OT) of a common object head of the PCEP message.

9. The element according to claim 8,
wherein the engine unit comprises information for identifying an internet protocol version 4 (IPv4) TNA address, internet protocol version 6 (IPv6) TNA address, and NASP TNA address in order to distinguish between the TNA address and node address in a TLV type of an endpoint object of the PCEP message.

10. The element according to claim 9,
wherein the engine unit incorporates the TNA address in the endpoint object, expands a generalized endpoint object and incorporates the TNA address into the expanded generalized endpoint object, or incorporates the TNA address into a newly defined PCEP.

11. The element according to claim 5,
wherein the engine unit uses the PCEP that comprises information for identifying the TNA address.

12. The element according to claim 1,
wherein the path computation element is connected to a Path Computation Client (PCC) and computes the path, and
the PCC uses the PCEP to transmit the TNA address.

13. A User Network Interface (UNI) path computation method comprising:
receiving a user network interface path computation message;
in response to a source address at a path computation request being a source Transport Network Assigned (TNA) address, converting the source TNA address into a source node address;
in response to a destination address at the path computation request being a destination TNA address, converting the destination TNA address into a destination node address; and
computing a path at the path computation request based on a domain where the destination node is located.

14. The method according to claim 13,
wherein the path computation request message and path computation response message use a Path Computation Element Protocol (PCEP) and an expanded PCEP.

15. The method according to claim 14,
wherein the path computation request message and path computation response message incorporate a source TNA address and a destination TNA address using an endpoint object of an PCEP message when using the PCEP.

16. The method according to claim 15,
wherein the PCEP message comprises information for identifying an internet protocol version 4 (IPv4) TNA address, internet protocol version 6 (IPv6) TNA address, and NASP TNA address in order to distinguish between the TNA address and node address in an Object Type (OT).

17. The method according to claim 16,
wherein the PCEP message comprises information for identifying an internet protocol version 4 (IPv4) TNA address, internet protocol version 6 (IPv6) TNA address, and NASP TNA address in order to distinguish between the TNA address and node address in a TLV type of an endpoint object.

18. The method according to claim 14,
wherein the path computation request message and path computation response message comprises information for identifying the TNA address in a predefined object in the PCEP.
